(19) United States
(12) Patent Application Publication
(10) Pub. No.: US 2019/0302992 A1
(43) Pub. Date: Oct. 3, 2019

(54) SMART TERMINAL AND METHOD FOR INTERACTING WITH ROBOT USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XUE-QIN ZHANG, Shenzhen (CN); NENG-DE XIANG, Shenzhen (CN); MING-SHUN HU, Shenzhen (CN)

(21) Appl. No.: 15/965,820

(22) Filed: Apr. 27, 2018

(30) Foreign Application Priority Data
Mar. 29, 2018 (CN) 201810273951.4

(51) Int. Cl. G06F 3/0484; G06F 3/0482; B25J 9/16

(52) U.S. Cl. CPC G06F 3/04847; B25J 9/161; G06F 3/0482

(57) ABSTRACT

A method for a smart terminal to interact with a robot includes generating an editing interface on a display device of the smart terminal, the editing interface comprising an action editing area, an expression editing area, a sound editing area, and an execution setting area. Actions are determinable, a visible expression is determinable, and sounds are also determinable by user. A manner of execution of such interaction contents can also be set. Such edited interaction content can be sent to the robot and executed accordingly.

### FIELD

The subject matter herein generally relates to interactive technology, and particularly to a smart terminal and a method for interacting with a robot using the smart terminal.

### BACKGROUND

Robots have various sensors and their own processors to provide a music service or a streaming service. They also provide services such as speech recognition, image recognition, and navigation. Controlling the robot conveniently can be problematic.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of one embodiment of a smart terminal.

FIG. 2 is a block diagram of one embodiment of the smart terminal of FIG. 2 including an interacting system.

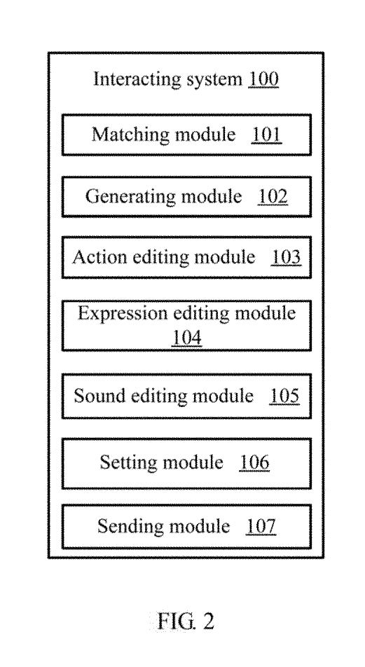

FIG. 3 illustrates a flow chart of an embodiment of a method for interacting with a robot using the smart terminal of FIG. 1.

FIG. 4 illustrates a block diagram of one embodiment of an editing interface on the smart terminal of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

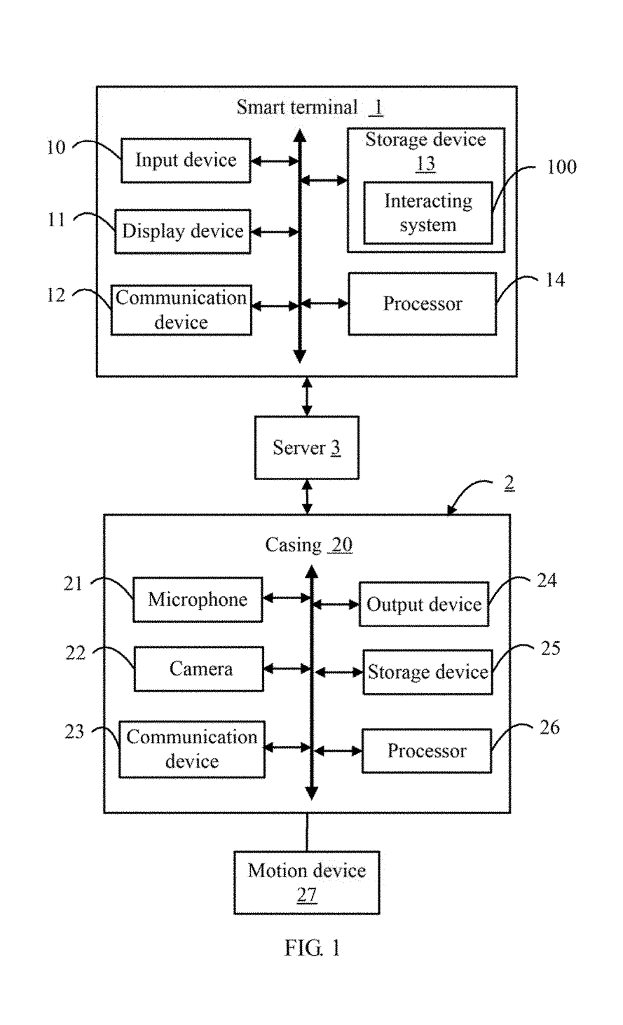

FIG. 1 is a block diagram of one embodiment of a smart terminal 1. Depending on the embodiment, the smart terminal 1 can include, but is not limited to, an input device 10, a display device 11, a communication device 12, a storage device 13, and at least one processor 14. The above components communicate with each other through a system bus. In at least one embodiment, the smart terminal 1 can be a mobile phone, a personal computer, a smart watch, a smart television, or any other suitable device. FIG. 1 illustrates only one example of the smart terminal 1 that can include more or fewer components than illustrated, or have a different configuration of the various components in other embodiments. For example, the smart terminal 1 further can include an electrical system, a sound system, an input/output interface, a battery, and an operating system.

In at least one embodiment, a user can interact with the smart terminal 1 by the input device 10. The user can use non-contact input device 10 to interact with the smart terminal 1. For example, the user can interact with the smart terminal 1 by inputting vocal or gestural commands, or through a remote. The input device 11 can also be a capacitive touch screen, a resistive touch screen, or other optical touch screen. The input device 11 also can be a mechanical key, for example, a key, a shifter, a flywheel key, and so on. When the input device 10 is a touch panel which covers the display device 11, the user can input information on the input device by a finger or a touch pencil.

In at least one embodiment, the display device 11 can be a liquid crystal display (LCD) or an organic light-emitting diode (OLED).

In at least one embodiment, the communication device 12 can communicate with any conventional wired network, wireless network, or both. For example, the smart terminal 1 can communicate with a robot 2 and a server 3 by the communication device 12.

The wired network can be any category of conventional wired communications, for example, the Internet, or local area network (LAN). The wireless network can be any category of conventional wireless communications, for example, radio, WIFI, cellular, satellite, and other broadcasting. Exemplary suitable wireless communication technologies include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZIGBEE, BLUETOOTH, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT), and others.

In at least one embodiment, the storage device 13 can be a memory device of the smart terminal 1. In other embodiments, the storage device 15 can be a secure digital card, or other external storage device such as a smart media card. In at least one embodiment, the storage device 15 can store an interacting system 100 of the smart terminal 1. The interacting system 100 can receive expression data that can be executed by the robot 2, and send the expression data to the server 3. The server 3 can convert the expression data to control commands, and send the control commands to the robot 2. The robot 2 can execute operations according to the control commands. In other embodiment, the interacting system 100 further can send the expression data to the robot 2 for controlling the robot 2 to execute expression operations.

The at least one processor 14 can be a central processing unit (CPU), a microprocessor, or other data processor chip that performs functions of the smart terminal 1.

In at least one embodiment, the robot 2 can include, but is not limited to, a casing 20, a microphone 21, a camera 22, a communication device 23, an output device 24, a storage device 25, and at least one processor 26. The microphone 21, the camera 22, the communication device 23, the output device 24, the storage device 25, and the at least one processor 26 are inside the casing 20. A motion device 27 is connected to the outside of the casing 20. The motion device 27 can enable and control movement of the robot 2 according to commands which are sent from the processor 26. For example, the robot 2 can be caused to move right/left, or forwards/backwards.

In at least one embodiment, the robot 2 further includes a driving device (not shown), the driving device can cause the robot 2 to move. The robot 2 further can include a power supply which is used to provide power to the robot 2.

In at least one embodiment, the microphone 21 can receive sound. The camera 22 can collect picture and/or video.

In at least one embodiment, the communication device 23 can communicate with any conventional network. For example, the robot 2 can communicate with the server 3 and/or the smart terminal 4 by the communication device 23. The output device 24 can include a loudspeaker, and the loudspeaker can output sound.

In at least one embodiment, the storage device 25 can be a memory device of the robot 2. In other embodiments, the storage device 25 can be a secure digital card, or other external storage device such as a smart media card. The at least one processor 26 can be a central processing unit (CPU), a microprocessor, or other data processor chip that performs functions of the robot 2.

In at least one embodiment, the interacting system 100 can include a matching module 101, a generating module 102, an action editing module 103, an expression editing module 104, a sound editing module 105, a setting module 106, and a sending module 107. The modules 101-107 include computerized codes in the form of one or more programs that may be stored in the storage device 13. The computerized codes include instructions that can be executed by the at least one processor 14.

In at least one embodiment, the matching module 101 can establish a connection between the smart terminal 1 and the robot 2. The connection is that the smart terminal 1 has authority to access the robot 2 by a password or a QR code. For example, when the smart terminal 1 needs to establish a connection with the robot 2, the smart terminal 1 can receive a password from the robot 2. When the user inputs the password through the user interface of the smart terminal 1, and the inputted password is the same as the received password, it is determined that the smart terminal 1 has authority to access the robot 2. The smart terminal 1 also can establish the connection with the robot 2 by scanning the QR code of the robot 2.

In at least one embodiment, when the smart terminal 1 is a phone, the matching module 101 can establish the connection between the smart terminal 1 and the robot 2 after inputting a verification code from the smart terminal 1. The verification code can be acquired by a phone number input through the user interface of the smart terminal 1.

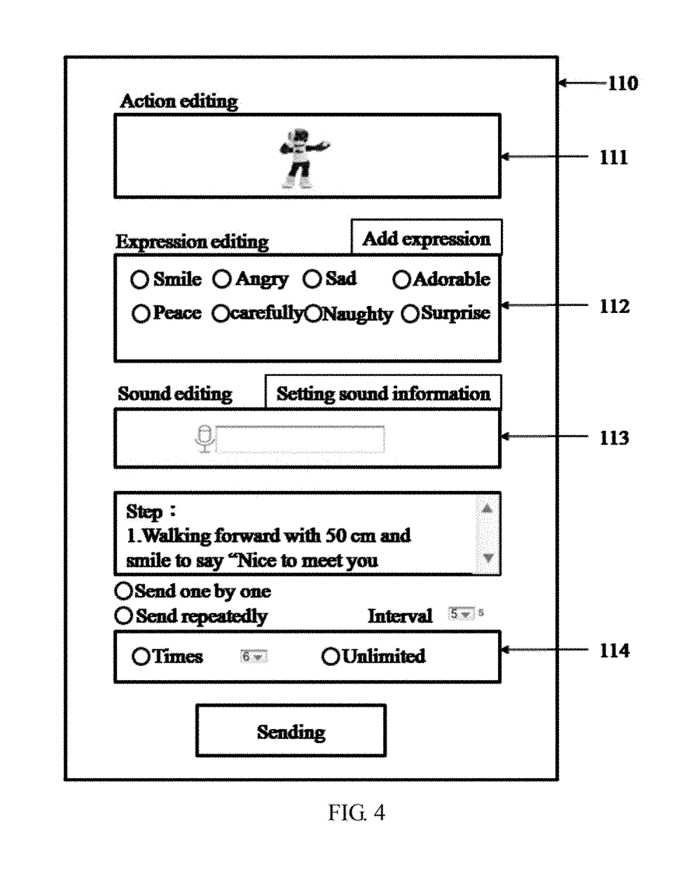

In at least one embodiment, the generating module 102 can generate an editing interface on the display device 11 for the user to edit interactions. As shown in FIG. 4, the editing interface 110 can include an action editing area 111, an expression editing area 112, a sound editing area 113, and an execution setting area 114.

In at least one embodiment, the manner of interactions and interactive control (interaction content) can include one or more of visual expression, sound, and action.

In at least one embodiment, the action editing module 103 can determine an action to perform in response to a user operation on the action editing area 111. The action can include, but is not limited to, arms movements (e.g., bending arms), legs movements, rotation directions, and angles of joints.

In at least one embodiment, the action editing module 103 can respond to the user operation during editing action of the robot 2 on the action editing area 111. For example, the action of the robot 2 can include rotation of arms, legs, or joints. The action editing module 103 can respond to the user editing operation regarding speed and times of actions of the robot 2. The action editing module 103 further can respond to the user editing operation regarding rotation direction and angle of actions of the robot 2.

In at least one embodiment, the expression editing module 104 can determine an expression in response to the user operation on the expression editing area 112. The expression can include shape of the expression and projected feeling of the expression. For example, the shape of the expression can be looking like a dog, a cat, or cute cartoon character. The projected feeling of the expression can be gladness, anger, sadness, affection, expression of dislike, surprised, scared, and so on. The expression editing area 112 can receive the user operation for editing the shape of the expression, the projected feeling of the expression, and the duration of the expression.

In at least one embodiment, the sound editing module 105 can determine sound information in response to the user operation on the sound editing area 113. The sound information can include words corresponding to the sound, timbre and tone of the sound. The sound editing area 112 can receive the user operation for editing the sound information.

In at least one embodiment, the setting module 106 can set a manner of execution in response to the user operation on the execution setting area 114.

In at least one embodiment, the manner of execution can include executing one of the interaction contents, or any combination of the interaction contents. The manner of execution can include the execution times and execution mode of the interaction content. The execution mode can include setting an interval between the interaction contents, and order of the interaction contents.

In at least one embodiment, the sending module 107 can generate edited interaction content according to at least one of the determined action, the determined expression, the determined sound, and the manner of execution, and can convert the edited interaction content to control commands and send same to the robot 2. The robot 2 can perform operations according to the control commands.

In at least one embodiment, the smart terminal 1 can remotely interact with more than one robot 2 simultaneously. For example, the smart terminal 1 can remotely interact with robot A, robot B, and robot C. The editing interface 110 further can include a selectable robot editing area (not shown), the interacting system 100 can determine which robot 2 is to receive the control command in response to the user operation on the selectable robot editing area.

In at least one embodiment, several smart terminals 1 can remotely interact with the robot 2. The several smart terminals 1 are different types of terminals. For example, the several smart terminals 1 can be a smart phone, a computer, a smart watch, and smart television.

In at least one embodiment, the smart terminal 1 and/or the server 3 can monitor the execution of the interaction content of the robot 2. For example, the smart terminal 1 can communicate with a camera which is set in the environment where the robot 2 is located. The camera can take photos and/or videos of the robot 2, and send the photos and/or videos to the smart terminal 1 and/or the server 3. The smart terminal 1 and/or the server 3 can monitor the robot 2 by means of the photos and/or videos.

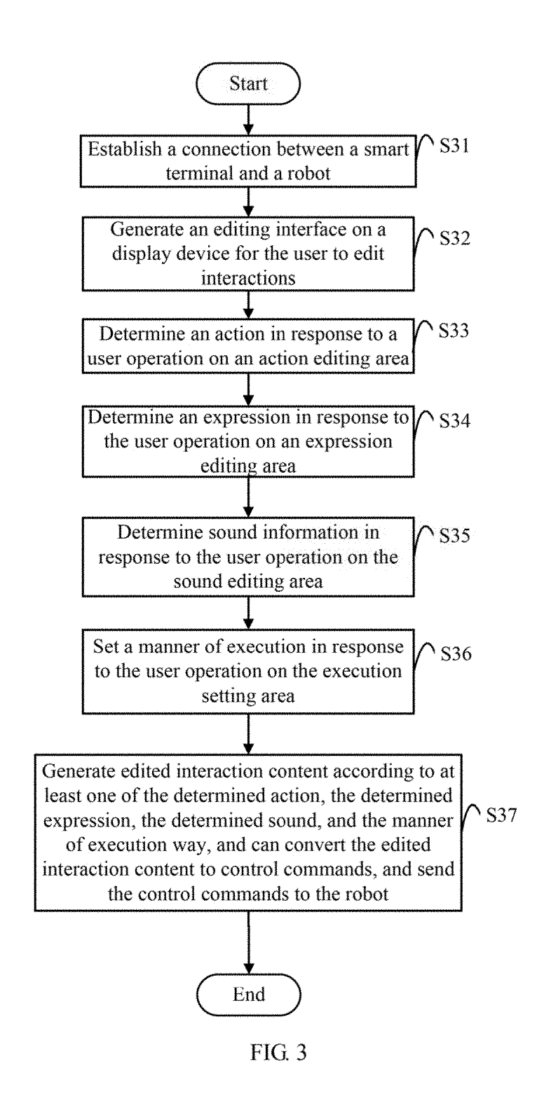

FIG. 3 illustrates a flowchart of a method which is presented in accordance with an embodiment. The method 300 is provided by way of example, as there are a variety of ways to carry out the method. The method 300 described below can be carried out using the configurations illustrated in FIG. 1, for example, and various elements of these figures are referenced in explaining method 300. Each block shown in FIG. 3 represents one or more processes, methods, or subroutines, carried out in the method 300. Additionally, the illustrated order of blocks is by example only and the order of the blocks can be changed according to the present disclosure. The method 300 can begin at block S31. Depending on the embodiment, additional steps can be added, others removed, and the ordering of the steps can be changed.

At block S31, the matching module 101 can establish a connection between the smart terminal 1 and the robot 2. The connection is that the smart terminal 1 has authority to access the robot 2 by a password or a QR code. For example, when the smart terminal 1 needs to establish a connection with the robot 2, the smart terminal 1 can receive a password from the robot 2. When the user inputs the password through the user interface of the smart terminal 1, and the inputted password is the same as the received password, it is determined that the smart terminal 1 has authority to access the robot 2. The smart terminal 1 also can establish the connection with the robot 2 by scanning the QR code of the robot 2.

At block S32, the generating module 102 can generate an editing interface on the display device 11 for the user to edit interactions. As shown in FIG. 4, the editing interface 110 can include an action editing area 111, an expression editing area 112, a sound editing area 113, and an execution setting area 114. In at least one embodiment, the manner of interactions and interactive control (interaction content) can include one or more of visual expression, sound, and action.

At block S33, the action editing module 103 can determine an action in response to a user operation on the action editing area 111. The action can include, but is not limited to, arms movements (e.g., bending arms), legs movements, rotation directions, and angles of joints.

In at least one embodiment, the action editing module 103 can respond to the user operation during editing action of the robot 2 on the action editing area 111. For example, the action of the robot 2 can include rotation of arms, legs, or joints. The action editing module 103 can respond to the user editing operation regarding speed and times of actions of the robot 2. The action editing module 103 further can respond to the user editing operation regarding rotation direction and angle of actions of the robot 2.

At block S34, the expression editing module 104 can determine an expression in response to the user operation on the expression editing area 112. The expression can include shape of the expression and projected feeling of the expression. For example, the shape of the expression can be looking like a dog, a cat, or cute cartoon character. The projected feeling of the expression can be gladness, anger, sadness, affection, expression of dislike, surprised, scared, and so on. The expression editing area 112 can receive the user operation for editing the shape of the expression, the projected feeling of the expression, and the duration of the expression.

At block S35, the sound editing module 105 can determine sound information in response to the user operation on the sound editing area 113. The sound information can include words corresponding to the sound, timbre and tone of the sound. The sound editing area 112 can receive the user operation for editing the sound information.

At block S36, the setting module 106 can set manner of execution in response to the user operation on the execution setting area 114. The manner of execution can include executing one of the interaction contents, and any combination of the interaction contents. The manner of execution can include the execution times and execution mode of the interaction content. The execution mode can include setting an interval between the interaction contents, and order of the interaction contents.

At block S37, the sending module 107 can generate edited interaction content according to at least one of the determined action, the determined expression, the determined sound, and the manner of execution, and can convert the edited interaction content to control commands and send same to the robot 2. The robot 2 can perform operations according to the control commands.

In at least one embodiment, the block S37 can be a step that the sending module 107 can send the edited interaction content to the robot 2, and the robot 2 can perform relevant operations based on the edited interaction content. Thus, the smart terminal 1 can control the robot 2 directly.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

1. A smart terminal comprising:
a display device;
a storage device;
at least one processor; and
the storage device further storing one or more programs that, when executed by the at least one processor, cause the at least one processor to:
generate an editing interface on the display device for the user to edit interaction content, wherein the editing interface comprises an action editing area, an expression editing area, a sound editing area, and an execution setting area;
determine an action in response to a user operation on the action editing area;
determine an expression in response to the user operation on the expression editing area, wherein the expression comprises shape of the expression, and duration of the expression;
determine sound information in response to the user operation on the sound editing area;
set a manner of execution in response to the user operation on the execution setting area; and
generate edited interaction content according to at least one of the determined action, the determined expression, the determined sound information, and the manner of execution.

2. The smart terminal according to claim 1, wherein the at least one processor is further caused to:
establish a connection between the smart terminal and a robot.

3. The smart terminal according to claim 2, wherein the at least one processor is further caused to:
convert the edited interaction content to control commands; and
send the control commands to the robot.

4. The smart terminal according to claim 2, wherein the at least one processor is further caused to:
send the edited interaction content to the robot.

5. The smart terminal according to claim 1, wherein the expression further comprises, projected feeling of the expression; and
the sound information comprises words corresponding to the sound, timbre and tone of the sound.

6. The smart terminal according to claim 4, wherein the editing interface further comprises a selectable robot editing area, wherein the selectable robot editing area determines which robot to receive information in response to the user operation.

7. The smart terminal according to claim 1, wherein the manner of execution comprises executing one of the interaction contents, any combination of the interaction contents, execution times of the interaction content, setting an interval between the interaction contents, and order of the interaction contents.

8. An interacting method applied in a smart terminal, the smart terminal comprising a display device, the method comprising:
generating an editing interface on the display device for the user to edit interaction content, wherein the editing interface comprises an action editing area, an expression editing area, a sound editing area, and an execution setting area;
determining an action in response to a user operation on the action editing area;
determining an expression in response to the user operation on the expression editing area, wherein the expression comprises shape of the expression, and duration of the expression;
determining sound information in response to the user operation on the sound editing area;
setting a manner of execution in response to the user operation on the execution setting area; and
generating edited interaction content according to at least one of the determined action, the determined expression, the determined sound information, and the manner of execution.

9. The method according to claim 8, wherein the method further comprising:
establishing a connection between the smart terminal and a robot.

10. The method according to claim 9, wherein the method further comprising:
converting the edited interaction content to control commands; and
sending the control commands to the robot.

11. The method according to claim 9, wherein the method further comprising:
sending the edited interaction content to the robot.

12. The method according to claim 8, wherein the expression further comprises, projected feeling of the expression; and
the sound information comprises words corresponding to the sound, timbre and tone of the sound.

13. The method according to claim 11, wherein the editing interface further comprises a selectable robot editing area, wherein the selectable robot editing area determines which robot to receive information in response to the user operation.

14. The method according to claim 8, wherein the manner of execution comprises executing one of the interaction contents, any combination of the interaction contents, execution times of the interaction content, setting an interval between the interaction contents, and order of the interaction contents.

15. A non-transitory storage medium having stored thereon instructions that, when executed by a processor of a smart terminal, causes the processor to perform an interacting method, the smart terminal comprising a display device, the method comprising:
generating an editing interface on the display device for the user to edit interaction content, wherein the editing interface comprises an action editing area, an expression editing area, a sound editing area, and an execution setting area;
determining an action in response to a user operation on the action editing area;
determining an expression in response to the user operation on the expression editing area, wherein the expression comprises shape of the expression, and duration of the expression;
determining sound information in response to the user operation on the sound editing area;
setting a manner of execution in response to the user operation on the execution setting area; and
generating edited interaction content according to at least one of the determined action, the determined expression, the determined sound information, and the manner of execution.

16. The non-transitory storage medium according to claim 15, wherein the method further comprising:
establishing a connection between the smart terminal and a robot.

17. The non-transitory storage medium according to claim 16, wherein the method further comprising:
converting the edited interaction content to control commands; and
sending the control commands to the robot.

18. The non-transitory storage medium according to claim 16, wherein the method further comprising:
sending the edited interaction content to the robot.

19. The non-transitory storage medium according to claim 15, wherein the expression further comprises projected feeling of the expression; and
the sound information comprises words corresponding to the sound, timbre and tone of the sound.

20. The non-transitory storage medium according to claim 18, wherein the editing interface further comprises a selectable robot editing area, wherein the selectable robot editing area determines which robot to receive information in response to the user operation.
